(19) United States
(12) Patent Application Publication
(10) Pub. No.: US 2003/0046860 A1
(43) Pub. Date: Mar. 13, 2003

(54) Vegetable fat-based candles

(75) Inventors: Tom Tiffany, Lincoln, IL (US); Ron Sleeter, Decatur, IL (US); Neil Widlak, Decatur, IL (US)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: Archer Daniels Midland Co.

(21) Appl. No.: 10/211,966

(22) Filed: Aug. 2, 2002

Related U.S. Application Data
(60) Provisional application No. 60/309,752, filed on Aug. 2, 2001.

(51) Int. Cl. C10L 5/00; C10L 7/00; C11C 5/00

(52) U.S. Cl. 44/275; 264/279

(57) ABSTRACT

The invention provides a candle body composition, and a candle made therefrom, wherein the candle body composition comprises at least about 51 percent of a vegetable fat having an iodine value of about 0 to about 80, preferably about 40 to about 80. The vegetable fat may comprise a partially or fully hydrogenated vegetable oil, such as soybean oil, palm oil, cottonseed oil, rapeseed oil and mixtures thereof. The candle body composition may further comprise up to about 49 weight percent of one or more crystal modifiers, such as fully hydrogenated vegetable oils having an iodine value of about 1 to about 20, fatty acids, esters of fatty acids, and mixtures thereof. The invention includes a method of forming candles using the above-described candle body composition.

### CROSS-REFERENCE TO RELATED APPLICATIONS

This application claims the benefit of Provisional Application Serial No. 60/309,752, filed Aug. 2, 2001, which is incorporated herein by reference in its entirety.

### FIELD OF THE INVENTION

The invention related to combustible candle body compositions and candles made therefrom.

### BACKGROUND OF THE INVENTION

Candles have been used as a source of lighting for many centuries. Although the discovery of electricity ended the widespread use of candles for general illumination, the $2 billion dollar candle industry continues to thrive due to the popularity of candles as aesthetically pleasing decorations in the home. In particular, scented candles have become increasingly popular.

Conventional candles are primarily formed using petroleum-based waxes, such as paraffin. However, there are problems associated with the use of petroleum-based compositions. For example, since petroleum is a non-renewable resource, the supply of paraffin produced by petroleum refining will eventually decline. Supply problems are exacerbated by new petroleum refining techniques that reduce or eliminate the paraffin wax byproduct.

There are also disadvantages associated with burning paraffin waxes. For example, burning petroleum-based candles can lead to aesthetically displeasing soot deposits that require cleaning. In some cases, soot deposits could require painting, or other types of resurfacing, of walls and other surfaces within the home. In addition, questions have been raised about possible adverse health affects from exposure to the combustion products emitted from paraffin wax candles. Since paraffin waxes are becoming increasingly scarce and disfavored as a candle component, there is a need for a suitable replacement for candle body compositions.

Although there here have been attempts in the art to utilize other naturally occurring materials, such as vegetable-based materials, in the manufacture of candles, there remains a need in the art for non-paraffin based candles that exhibit satisfactory burning and appearance characteristics.

### SUMMARY OF THE INVENTION

The present invention provides a combustible candle body composition, and a candle made therefrom, which does not contain paraffin wax or any other petroleum-based product as a primary ingredient. Instead, the candle body composition of the invention contains a vegetable fat having an iodine value of about 0 to about 80 as a primary component. The use of a vegetable fat-based candle composition avoids the disadvantages associated with the use of petroleum-based compositions and utilizes natural and renewable resources.

The combustible candle body composition of the present invention comprises a vegetable fat having an iodine value of about 0 to about 80 in an amount of at least about 51 weight percent based on the total weight of the candle body composition, preferably at least about 80 weight percent, and more preferably at least about 90 weight percent. Vegetable fats having an iodine value of between about 20 to about 80, particularly between about 20 to about 60, are preferred. The vegetable fat component may be derived from partially hydrogenated vegetable oils, such as soybean, palm, cottonseed, or mixtures thereof. Alternatively, the vegetable fat may be derived from fully hydrogenated vegetable oils, such as soybean, palm, rapeseed, and mixtures thereof. The vegetable fats may be fractionated, interesterified, or blended.

The above described vegetable fats may be used alone or in combination with other fats as the main ingredient of the candle body, or may be used in combination with one or more crystal modifiers. For example, a crystal modifier may be added in an amount up to about 49 weight percent based on the total weight of the candle body composition, preferably less than about 20 weight percent, and more preferably less than about 10 weight percent. Examples of suitable crystal modifiers include fully hydrogenated vegetable oils having an iodine value of about 1 to about 20, fatty acids, esters of fatty acids such as mono- and diglycerides, esters of alcohols and polyalcohols, esters of organic acid alcohols, such as lactic acid, interesterified fats, petroleum-based waxes and mixtures thereof. More specific examples of crystal modifiers useful in the invention include palm oil, coconut oil, partially or fully hydrogenated soybean oil, rapeseed oil, palm oil, cottonseed oil, medium chain triglycerides, saturated or unsaturated C6-C24 fatty acids, monoglycerides and diglycerides prepared from the above-described fats and oils having an iodine value of about 1 to about 80, propylene glycol monoesters, esters of vegetable oil, sorbitan tristearate, and mixtures thereof.

The present invention includes candles formed using the above-described candle body compositions. The candles of the invention comprise a solidified combustible candle body composition as described above and a candlewick extending into the candle body composition.

The present invention also provides a method of forming a candle. The method comprises melting a vegetable fat having an iodine value of about 0 to about 80 to form a liquified vegetable fat. The liquified vegetable fat may then be contacted with a candlewick such that a portion of the candle wick is coated with vegetable fat. Thereafter, the candlewick and vegetable fat coated thereon is cooled to form a solid candle. The method of contacting the vegetable fat with the candlewick will vary. In the formation of “dipped” candles, the contacting step will comprise repeatedly dipping a candlewick into the liquified vegetable fat with cooling periods between each dipping step. Alternatively, to form a molded candle, the contacting step would comprise positioning the candlewick within a mold and pouring the vegetable fat into the mold such that the vegetable fat encases at least a portion of the candlewick. After the cooling step, the solid candle may be removed from the mold or, in some cases, the mold is retained as a container for the candle. The melting step preferably comprises heating the vegetable fat at a temperature of about 120° F. to about 200° F. The melting temperature is determined by the melting points of the components used in the candle composition. Additionally, it is preferable to cool the vegetable fat to a temperature of about 110° F. to about 180° F. prior to contacting vegetable fat with the candlewick, such as by pouring the vegetable fat into a mold containing the candlewick. The mold or candle container may be cooled or preheated prior to contact with the vegetable fat. So-called “formed” candles can be formed by compressing the candle body material in its cooled solid state to produce free-standing candles.

As noted above, the candle body composition may further comprise one or more crystal modifiers. In this case, the method of forming the candle will include the steps of adding up to about 49 weight percent of at least one crystal modifier to the liquified vegetable fat and mixing the crystal modifier with the vegetable fat to form a uniform candle body composition.

### BRIEF DESCRIPTION OF THE DRAWINGS

Having thus described the invention in general terms, reference will now be made to the accompanying drawings, which are not necessarily drawn to scale, and wherein:

FIG. 1 is a perspective view of a candle.

### DETAILED DESCRIPTION OF THE INVENTION

The present invention now will be described more fully hereinafter with reference to the accompanying drawings, in which preferred embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art. Like numbers refer to like elements throughout.

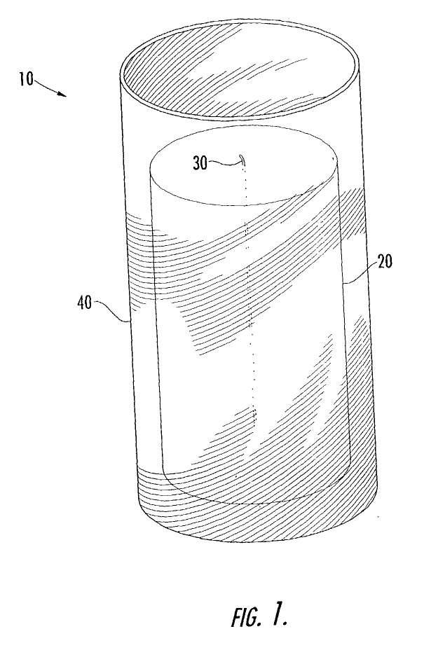

The present invention provides a vegetable fat-based combustible candle body composition useful in forming candles, such as the candle pictured in FIG. 1. As noted in the figure, a candle 10 typically comprises a solidified candle body composition 20 encasing at least a portion of a longitudinally extending wick 30. The candlewick 30 may comprise any conventional material known for use in candles, such as various natural and synthetic fibers. Optionally, the candle may be positioned within a container 40.

The primary component of the combustible candle body composition 20 is a vegetable fat having an iodine value (IV) of about 0 to about 80. Preferably, the iodine value of the vegetable fat is 20 to about 80, more preferably about 20 to about 60. The vegetable fat is present in an amount of at least about 51 weight percent based on total candle body composition weight, preferably at least about 80 weight percent, more preferably at least about 90 weight percent, and in some cases as much as about 95 to about 100 weight percent. The term “vegetable fat” is intended to include any fat derived from oils extracted from plants that are solid or semi-solid at room temperature and exhibit a crystalline structure. Such vegetable fats are comprised primarily of a mixture of glyceryl esters of fatty acids.

Traditionally, vegetable fat systems are heated then cooled to form crystal structure systems which have wide ranging functional properties for use as butter or animal fat substitutes (e.g. margarine and shortenings). The crystalline product retains the crystal structure throughout its functional food use. If melted and recrystallized, it would separate into fractions. Candle technology requires a different approach because a candle is repeatedly heated, melted and recrystallized. A candle body material must be capable of maintaining a substantially smooth and uniform crystal structure through a number of heating and cooling cycles.

It has been discovered that increases in iodine value, which is an indication of the degree of unsaturation and is related to the melting point of the fat, tends to reduce the brittleness, cracking, tunneling, and braininess associated with highly saturated “hard” fats having very low iodine values. Hard fats also have the tendency to contract from the container housing a poured candle, leading to a tendency of the candle to fall out of the container. If the iodine value becomes too high, and consequently the melting point becomes too low, a vegetable fat-based candle tends to become soft and has a tendency to oil out. Vegetable fats with iodine values between about 40 to about 80 produce poured candles with less tunneling, less braininess, and less brittleness as compared to poured candles produced from vegetable fats with iodine values below 40. Braininess is the expansion of fat crystals that is unappealing for most candle applications. Tunneling is the result of poor melting across the surface diameter of the candle leading to a pit or tunnel in the center of the candle, which increases in depth as the candle is burned. Tunneling leaves un-melted material around the outside diameter of the candle.

The vegetable fat may be a partially hydrogenated vegetable oil or a fully hydrogenated vegetable oil. For purposes of the invention, the exact degree of hydrogenation is not critical. The vegetable oils must be hydrogenated sufficiently to render the candle body composition solid or semi-solid at room temperature. Typically, partially hydrogenated vegetable oils have a degree of hydrogenation ranging from 0 to about 80. Fully hydrogenated vegetable oils in the art typically have a degree of hydrogenation in the range of 0 to about 10. Preferably, the melting point of the vegetable fat component is about 110° F. to about 170° F., more preferably about 120° F. to about 140° F.

Specific examples of partially or fully hydrogenated vegetable oils useful as the vegetable fat component includes soybean oil, palm oil, cottonseed oil, rapeseed oil and mixtures thereof. The fats or oils can be interesterified, fractionated or blended.

Although the above-described vegetable fat component may be used alone, particularly when using vegetable fats having an iodine value of about 20 to about 80, one or more crystal modifiers may be included in the candle body composition. The term “crystal modifier” is intended to encompass any ingredient that modifies the crystal structure of the candle body composition such that improper crystallization is retarded and undesirable characteristics, such as brittleness, braininess, and tunneling, are reduced. The crystal modifiers are present in an amount up to about 20 weight percent, more preferably in an amount up to about 10 weight percent, and even as low as about 5 weight percent or lower.

Preferred crystal modifiers are selected from the group consisting of fully hydrogenated vegetable oils, such as those having an iodine value of about 1 to about 20, fatty acids, esters of fatty acids, esters of vegetable oils, and mixtures thereof. Examples of suitable fully hydrogenated vegetable oils for use as a crystal modifier include palm oil, coconut oil, cottonseed oil, soybean oil, rapeseed oil, and mixtures thereof. Saturated or unsaturated C6-C24 fatty acids are particularly preferred fatty acids for use as crystal modifiers. Esters of fatty acids that are particularly preferred include monoglycerides having an iodine value of about 1 to about 80, diglycerides having an iodine value of about 1 to about 80, propylene glycol monoesters, canola methyl esters, sorbitan tristearate, and mixtures thereof.

Certain esters of fatty acids are particularly preferred for use as crystal modifiers in the present invention. For example, a mixture of monoglycerides and diglycerides having an iodine value of about 1 to about 60, preferably about 1 to about 30, produce a candle having good burning and appearance characteristics.

In one embodiment, a rapeseed oil having an iodine value of about 1 to about 60, preferably about 1 to about 30, or even more preferably about 1 to about 10, produces a candle having good pouring, forming, burning and appearance characteristics when used as the primary candle component or as a crystal modifier.

Other candle ingredients and additives known in the art may be included in the candle body composition without departing from the invention. For example, dyes or pigments may be added to adjust the appearance of the candle. In addition, fragrant oils or other scented components may be incorporated into the candle body composition so that the candle emits a pleasant scent. Typically, these types of components that adjust the aesthetic qualities of the candle are present in relatively minor amounts, such as less than about 15 weight percent.

The present invention also provides a method of forming a candle. The method comprises melting one or more vegetable fats having an iodine value of about 0 to about 80 to form a liquefied vegetable fat. The liquefied vegetable fat may then be contacted with a candlewick such that a portion of the candle wick is coated with vegetable fat. Thereafter, the candlewick and vegetable fat coated thereon are cooled to form a solid candle. The method of contacting the vegetable fat with the candlewick will vary. In the formation of “dipped” candles, the contacting step will comprise repeatedly dipping a candlewick into the liquefied vegetable fat with cooling periods between each dipping step. Alternatively, to form a molded candle, the contacting step would comprise positioning the candlewick within a mold and pouring the vegetable fat into the mold such that the vegetable fat encases at least a portion of the candlewick. After the cooling step, the solid candle may be removed from the mold or, if desired, the mold may be retained as a container for the candle. The melting step preferably comprises heating the vegetable fat at a temperature of about 120° F. to about 200° F. Additionally, it is preferable to cool the vegetable fat to a temperature of about 110° F. to about 180° F. prior to contacting vegetable fat with the candlewick, such as by pouring the vegetable fat into a mold containing the candlewick.

As noted above, the candle body composition may further comprise one or more crystal modifiers. In this case, the method of forming the candle will include the steps of adding up to about 49 weight percent of at least one crystal modifier to the liquefied vegetable fat and mixing the crystal modifier with the vegetable fat to form a uniform candle body composition.

The following examples are given to illustrate the invention, but should not be considered in limitation of the invention.

### EXPERIMENTAL

To produce the candles tested, the vegetable fat component was heated to 180° F. in order to liquefy the material. The crystal modifier components, if present, were then added to the molten fat and agitated to ensure complete mixing. The blend of fat and modifier was then cooled slowly to 140° F. Thereafter, the blend was poured into a glass container (5.5 cm deep and 7.5 wide) containing a candlewick. The material was allowed to cool for 24 hours prior to evaluation.

The candles were evaluated for surface smoothness, uniformity, and hardness. The candles were then burned for a period of 4 to 6 hours. During the burning of the candles, observations were made as to the width and depth of the melt pool and appearance. This data is reproduced in the tables below. It was also observed that vegetable-based candles are less sooty than petroleum-based candles.

The following is a list of abbreviations appearing in the tables:

IV—iodine value

PHSBO—partially hydrogenated soybean oil

Mono—monoglyceride

Di—diglyceride

PGME—propylene glycol monoester

DMG—distilled monoglyceride

PHCotton—partially hydrogenated cottonseed oil

TABLE 1
Initial Fat and Crystal Modifier Evaluation - Observations Prior to Burning

| Fat Blend | Observations/Appearance |
|---|---|
| 100% 20 IV PHSBO | Larger fissures, braininess, |
| | uneven surface |
| 100% 32 IV PHSBO | Very grainy surface, slight |
| | fissures on periphery |
| 100% 42 IV PHSBO | Smooth and lumpy areas, no |
| | fissures |
| 90% 42 IV PHSBO/10% 3 IV Mono | Very smooth surface, no fissures, |
| & Di's | dull |
| 90% 42 IV PHSBO/10% Palm | Smooth surface, no fissures, |
| Stearin | shiny |
| 90% 42 IV PHSBO/10% Coconut Oil | Smooth, no fissures, shiny |
| 90% 42 IV PHSBO/10% PGME | Smooth surface, no fissures, |
| | slight blotchy |
| 90% 42 IV PHSBO/10% 25 IV | Grainy surface, no fissures |
| (DMG 40) | |
| 90% 42 IV PHSBO/10% Mixed Fatty | Severe graininess |
| Acids | |
| 90% 42 IV PHSBO/70 IV Mono's & | Smooth, no fissures, shiny |
| Di's | |
| 100% 33 IV PHSBO/PHCotton | Slight grainy, small fissures |
| | toward edge |
| 100% 74 IV PHSBO/PHCotton | Smooth, soft |
| 90% 74 IV PHSBO/PHCotton/10% | Smooth surface, much more firm |
| 3IV Mono & Diglycerides | than 100% 74 IV |
| | PHSBO/PHCotton |
| 100% 69 IV PHSBO | Slightly uneven surface, slight |
| | softness |
| 90% 69 IV PHSBO/10% 3 IV Mono | Very smooth surface, more firm |
| and Diglycerides | than 100% 69 IV PHSBO |

TABLE 2
Initial Fat and Crystal Modifier Evaluation - Observations After Burning

| | Observations/Appearance |
|---|---|
| | (burn radius/ |
| Fat Blend | depth/wick/appearance) |
| 100% 20 IV PHSBO | Severe braininess, severe tunneling |
| 100% 32 IV PHSBO | Some braininess, tunneling |
| 100% 42 IV PHSBO | 5.5 cm/4.5 cm/carbon balls/ |
| | braininess |
| 90% 42 IV PHSBO/10% 3 IV Mono | 5.5 cm/4.0 cm/smooth surfaces, |
| & Di's | some cracks |
| 90% 42 IV PHSBO/10% Palm | 5.5 cm/1.8 cm/slight smooth |
| Stearin | surfaces |
| 90% 42 IV PHSBO/10% Coconut | 5.0 cm/2.0 cm/carbon balls/ |
| Oil | |
| 90% 42 IV PHSBO/10% PGME | 5.0 cm/3.1 cm/brainy |
| 90% 42 IV PHSBO/10% 25 IV | 6.0 cm/5.0 cm/carbon balls/ |
| (DMG 40) | smooth |
| 90% 42 IV PHSBO/10% Mixed | 6.5 cm/4 cm/slight braininess/ |
| Fatty Acids | no carbon balls |
| 90% 42 IV PHSBO/70 IV Mono's | 4.5 cm/4.0/tunneling/slight |
| & Di's | braininess |
| 100% 33 IV PHSBO/PHCotton | 5.5 cm/3.5/smooth ,shiny |
| 100% 74 IV PHSBO/PHCotton | 5.0 cm/1.0 cm/soft/no |
| | braininess |
| 90% 74 IV PHSBO/PHCotton/10% | 7.0 cm/3.0 cm/soft to touch, |
| 3IV Mono & Diglycerides | no tunneling, no braininess |
| 100% 69 IV PHSBO | 7.5 cm/3.0 cm/no braininess/no |
| | tunneling, slightly soft |
| 90% 69 IV PHSBO/10% 3 IV Mono | 7.5 cm/3.0 cm/no braininess/no |
| and Diglycerides | tunneling, more firm than 100% |
| | 69 IV PHSBO |

TABLE 3
Evaluation of 54 IV Partially Hydrogenated Soybean Oil - Observations
Prior to Burning

| Fat Blend | Observations |
|---|---|
| 100% 54 IV PHSBO | Smooth surface, blotchy |
| | appearance |
| 90% 54 IV PHSBO/10% 3 IV (52% | Very smooth surface, consistent |
| mono) Mono & Diglycerides | coloring |
| 90% 54 IV PHSBO/10% 3 IV Mono | Very smooth surface, consistent |
| and Diglycerides | coloring, slight contraction from |
| | sides of glass container. |
| 90% 54 IV PHSBO/10% Canola | Uneven surface, friable |
| Methyl Esters | |
| 90% 54 IV PHSBO/10% Sorbitan | Smooth surface, very slight |
| Tristearate | graininess, slight contraction |
| | from glass surface |
| 90% 54 TV PHSBO/10% Mixed | Moderate grainy surface, uneven |
| Fatty Acids | coloring |
| 80% 54 IV PHSBO/10% 3 IV (52% | Very smooth surface, slight |
| mono) Mono & Diglycerides/10% | uneven coloring |
| Mixed Fatty Acids | |
| 80% 54 IV PHSBO/10% 3 IV (52% | Smooth surface, slight uneven |
| mono) Mono & Diglycerides/10% | coloring |
| Canola Methyl Esters | |
| 90% 54 TV PHSBO/10% Palm Titer | Slightly rough surface, slight |
| | gloss |
| 80% 54 TV PHSBO/20% Palm Titer | Slightly rough surface, cracking |

TABLE 4
Evaluation of 54 IV Partially Hydrogenated Soybean Oil - Observations
During and After Burning

| Fat Blend | Observations |
|---|---|
| 100% 54 IV PHSBO | 2.0 cm flame, 5.5 cm pool, smooth |
| | surfaces, no braininess, slight |
| | tunneling |
| 90% 54 TV PHSBO/10% 3 IV (52% | 2.0 cm flame, 5.5 cm pool, |
| mono) Mono & Diglycerides | smooth surfaces, slight tunneling |
| 90% 54 IV PHSBO/10% 3 TV Mono | 2.0 cm flame, 5.5 cm pool, smooth |
| and Diglycerides | surfaces, no real tunneling |
| 90% 54 IV PHSBO/10% Canola | 1.5 cm flame, 5.5 cm pool, |
| Methyl Esters | moderate tunneling, slight |
| | braininess |
| 90% 54 IV PHSBO/10% Sorbitan | 3.0 cm flame, 3.5 cm pool, no |
| Tristearate | braininess, smooth surfaces |
| 90% 54 IV PHSBO/10% Mixed | 1.5 cm flame, 5.5 cm pool, slight |
| Fatty Acids | braininess, slight tunneling |
| 80% 54 IV PHSBO/10% 3 IV (52% | 1.5 cm flame, 5.0 cm pool, smooth |
| mono) Mono & Diglycerides/10% | surfaces, tunneling |
| Mixed Fatty Acids | |
| 80% 54 IV PHSBO/10% 3 IV (52% | 2.0 cm flame, 5.5 cm pool, smooth |
| mono) Mono & Diglycerides/10% | surfaces, slight tunneling |
| Canola Methyl Esters | |
| 90% 54 IV PHSBO/10% Palm Titer | 1.8 cm flame, 6.3 cm pool, no |
| | tunneling, no braininess |
| 80% 54 IV PHSBO/20% Palm Titer | 2.0 cm flame, 5.6 cm pool, no |
| | tunneling, no braininess |

TABLE 5
Evaluation of Palm Stearin and Various Modifiers - Prior to Burning

| Fat Blend | Observations |
|---|---|
| 100% Palm Stearine | Severe braininess, sunken center |
| | around wick, soft to touch |
| 95% Palm Stearin/5% 5 IV Hydro- | Smooth surface, few bumps, more |
| genated Palm Oil | firm to touch than 100% Palm |
| | Stearin, no contraction from sides. |
| 85% Palm Stearin/15% 5 IV Hydro- | Smooth surface, few bumps, firm |
| genated Palm Oil | to touch, no contraction from sides |
| 80% Palm Stearin/20% 5 IV Hydro- | Smooth surface, few bumps, very |
| genated Palm Oil | firm to touch |
| 90% Palm Stearin/10% 3 IV Mono | Smooth surface, slight contraction |
| and Diglycerides | from sides of glass |
| 80% Palm Stearin/10% 20 IV Mono | Smooth surface, firm to touch, no |
| and Diglycerides | contraction |
| 90% Palm Stearin/10% 40 IV Mono | Smooth surface, few bumps, |
| and Diglycerides | |
| 90% Palm Stearin/10% 54 IV Mono | Very rough surface, no contraction |
| and Diglycerides | |
| 90% Palm Stearin/10% 3 IV (52 | Smooth surface, slight waxy to |
| αmono) Mono & Diglycerides | touch, no contraction |
| 90% Palm Stearin/10% Palm Stearin | Smooth but bumpy surface, no |
| Mono and Diglycerides | contraction |

TABLE 6
Evaluation of Palm Stearin and Various Modifiers - During and After
Burning

| | Observations |
|---|---|
| | (2 hours of burning and |
| Fat Blend | after cooling |
| 100% Palm Stearine | 7.5 cm pool, 2.0 cm flame, large |
| | carbon ball, severe braininess upon |
| | cooling |
| 95% Palm Stearin/5% 5 IV Hydro- | 6.7 cm pool, 1.8 cm flame, large |
| genated Palm Oil | carbon balls, rough surface upon |
| | cooling |
| 85% Palm Stearin/15% 5 IV Hydro- | 6.8 cm pool, 2.0 cm flame, carbon |
| genated Palm Oil | balls, smooth surface upon cooling |
| 80% Palm Stearin/20% 5 IV Hydro- | 6.8 cm pool, 2.0 cm flame, carbon |
| genated Palm Oil | balls, slight rough uneven surface |
| | upon cooling |
| 90% Palm Stearin/10% 3 IV Mono | 6.5 cm pool, 1.8 cm flame, carbon |
| and Diglycerides | balls, smooth surface on edges, |
| | rough surface near wick after |
| | cooling |
| 90% Palm Stearin/10% 20 IV Mono | 5.5 cm pool, 2.0 cm flame, gel |
| and Diglycerides | like melt pool, smooth surfaces |
| | upon cooling |
| 90% Palm Stearin/10% 40 IV Mono | 6.2 cm pool, 2.2 cm flame, carbon |
| and Diglycerides | balls, braininess upon cooling |
| 90% Palm Stearin/10% 54 IV Mono | 5.0 cm pool, 3.0 cm flame, small |
| and Diglycerides | carbon balls, braininess upon |
| | cooling |
| 90% Palm Stearin/10% 3 IV (52% | 5.0 cm pool, 2.0 cm flame, no |
| mono) Mono & Diglycerides | carbon balls, smooth surfaces upon |
| | cooling |
| 90% Palm Stearin/10% Palm Stearin | 7.0 cm pool, 1.8 cm flame, carbon |
| Mono and Diglycerides | balls, moderate braininess upon |
| | cooling |

TABLE 7
Evaluation of Various Candle Fat Blends

| Fat Blend | Observations |
|---|---|
| 97.35% 54 PHSBO/1.0% 3 IV Mono | Full Pool, smooth surface, slight |
| & Di's/1.0% Palm Titer/0.4% color/ | bloom |
| 0.25% Sorbitan Tristearate | |
| 99.75% 54 IV PHSBO/0.25% | Full Pool, smooth surface, slight |
| Sorbitan Tristearate | bloom |
| 98.75% 54 IV PHSBO/1.0% Palm | Full Pool, smooth surface, slight |
| Titer/ 0.25% Sorbitan Tristearate | bloom |
| 95% Palm Stearine/5% Palm Titer | Smooth surface, no fissures, full |
| | melt pool, slight braininess, no |
| | tunneling |
| 90% Palm Stearine/10% Palm Titer | Smooth surface, no fissures, full |
| | melt pool, no braininess, no |
| | tunneling. |
| 98% Palm Stearine/2% 3 IV Mono | Severe braininess, slight tunneling, |
| and Diglycerides (52% alpha mono) | ½ burn pool |
| Palm Stearine/4% 3 IV Mono and | Severe braininess, slight tunneling, |
| Diglycerides (52% alpha mono) | ½ burn pool |
| Palm Stearine/2% 3 IV Mono and | Uneven surface, some braininess, |
| Diglycerides (40% alpha mono) | full melt pool |
| Palm Steraine/4% 3 IV Mono and | Slight smooth surface, some |
| Diglycerides (40% alpha mono) | braininess, full melt pool |
| 54 IV PHSBO/2% (3 IV Mono and | Smooth surface, ½ melt pool, no |
| Diglycerides (40% alpha mono) | braininess |
| 54 IV PHSBO/2% (3 IV Mono and | Smooth surface, full melt pool, no |
| Diglycerides (40% alpha mono) | braininess |
| 100% Fully Hydrogenated High | 2.0 cm flame, 4.5 cm pool, slight |
| Erucic Acid Rapeseed Oil/Low | tunneling, very smooth surface |
| Erucic Acid Rapeseed Oil | |

Many modifications and other embodiments of the invention will come to mind to one skilled in the art to which this invention pertains having the benefit of the teachings presented in the foregoing descriptions and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. A combustible candle body composition, comprising at least about 51 weight percent of a vegetable fat having an iodine value of about 0 to about 80.

2. The candle body composition according to claim 1, wherein the iodine value of said vegetable fat is about 40 to about 80.

3. The candle body composition according to claim 1, wherein the iodine value of said vegetable fat is about 40 to about 60.

4. The candle body composition according to claim 1, wherein said vegetable fat is present in an amount of at least about 90 weight percent.

5. The candle body composition according to claim 1, wherein said vegetable fat is a partially hydrogenated vegetable oil.

6. The candle body composition according to claim 5, wherein the partially hydrogenated vegetable oil is selected from the group consisting of soybean oil, palm oil, cottonseed oil, rapeseed oil and mixtures thereof.

7. The candle body composition according to claim 1, wherein said vegetable fat is a fully hydrogenated vegetable oil.

8. The candle body composition according to claim 7, wherein the fully hydrogenated vegetable oil is selected from the group consisting of soybean oil, palm oil, cottonseed oil, rapeseed oil and mixtures thereof.

9. The candle body composition according to claim 1, further comprising a crystal modifier in an amount up to about 49 weight percent.

10. The candle body composition according to claim 9, wherein said crystal modifier is present in an amount up to about 20 weight percent.

11. The candle body composition according to claim 9, wherein the crystal modifier is selected from the group consisting of fully hydrogenated vegetable oils having an iodine value of about 1 to about 20, fatty acids, esters of fatty acids, and mixtures thereof.

12. The candle body composition according to claim 9, wherein the crystal modifier is a fully hydrogenated vegetable oil having an iodine value of about 1 to about 20, the fully hydrogenated vegetable oil being selected from the group consisting of soybean oil, palm oil, cottonseed oil, rapeseed oil and mixtures thereof.

13. The candle body composition according to claim 9, wherein the crystal modifier comprises one or more saturated or unsaturated C6-C24 fatty acids.

14. The candle body composition according to claim 9, wherein the crystal modifier is an ester of a fatty acid selected from the group consisting of monoglycerides having an iodine value of about 1 to about 80, diglycerides having an iodine value of 20 about 1 to about 80, propylene glycol monoesters, canola methyl esters, sorbitan tristearate, and mixtures thereof.

15. A combustible candle body composition, comprising:
at least about 90 weight percent of a vegetable fat having an iodine value of about 20 to about 80; and
up to about 10 weight percent of a crystal modifier, said crystal modifier being selected from the group consisting of fatty acids, esters of fatty acids, and mixtures thereof.

16. The candle body composition according to claim 15, wherein the iodine value of said vegetable fat is about 40 to about 80.

17. The candle body composition according to claim 15, wherein the iodine value of said vegetable fat is about 40 to about 60.

18. The candle body composition according to claim 15, wherein said vegetable fat is selected from the group consisting of soybean oil, palm oil, cottonseed oil, rapeseed oil and mixtures thereof.

19. The candle body composition according to claim 15, wherein said vegetable fat is a partially hydrogenated vegetable oil selected from the group consisting of soybean oil, palm oil, cottonseed oil, rapeseed oil and mixtures thereof.

20. The candle body composition according to claim 15, wherein said vegetable fat is a fully hydrogenated vegetable oil selected from the group consisting of soybean oil, palm oil, cottonseed oil, rapeseed oil and mixtures thereof.

21. The candle body composition according to claim 15, wherein the crystal modifier is an ester of a fatty acid selected from the group consisting of monoglycerides having an iodine value from about 1 to about 80, diglycerides having an iodine value from about 1 to about 80, propylene glycol monoesters, canola methyl esters, sorbitan tristearate, and mixtures thereof.

22. The candle body composition according to claim 15, wherein the crystal modifier comprises a mixture of monoglycerides and diglycerides having an iodine value from about 1 to about 60.

23. The candle body composition according to claim 22, wherein the crystal modifier comprises a mixture of monoglycerides and diglycerides having an iodine value from about 1 to about 30.

24. A candle, comprising:
a solidified combustible candle body composition, comprising at least about 80 weight percent of a vegetable fat having an iodine value of about 20 to about 80; and
a candlewick extending into said candle body composition.

25. The candle according to claim 24, wherein the iodine value of said vegetable fat is about 40 to about 80.

26. The candle according to claim 24, wherein the iodine value of said vegetable fat is about 40 to about 60.

27. The candle according to claim 24, wherein said vegetable fat is present in an amount of at least about 90 weight percent.

28. The candle according to claim 24, wherein said vegetable fat is a partially hydrogenated vegetable oil.

29. The candle according to claim 28, wherein the partially hydrogenated vegetable oil is selected from the group consisting of soybean oil, palm oil, cottonseed oil, rapeseed oil and mixtures thereof.

30. The candle according to claim 24, wherein said vegetable fat is a fully hydrogenated vegetable oil.

31. The candle according to claim 30, wherein the fully hydrogenated vegetable oil is selected from the group consisting of soybean oil, palm oil, cottonseed oil, rapeseed oil and mixtures thereof.

32. The candle according to claim 24, wherein said candle body composition further comprises a crystal modifier in an amount up to about 20 weight percent.

33. The candle according to claim 32, wherein said crystal modifier is present in an amount up to about 10 weight percent.

34. The candle according to claim 32, wherein the crystal modifier is selected from the group consisting of fully hydrogenated vegetable oils having an iodine value of about 1 to about 20, fatty acids, esters of fatty acids, and mixtures thereof.

35. The candle according to claim 32, wherein the crystal modifier is a fully hydrogenated vegetable oil having an iodine value of about 1 to about 20, the fully hydrogenated vegetable oil being selected from the group consisting of palm oil, coconut oil, and mixtures thereof.

36. The candle according to claim 32, wherein the crystal modifier comprises one or more saturated or unsaturated C6-C24 fatty acids.

37. The candle according to claim 32, wherein the crystal modifier is an ester of a fatty acid selected from the group consisting of monoglycerides having an iodine value of about 1 to about 80, diglycerides having an iodine value of about 1 to about 80, propylene glycol monoesters, canola methyl esters, sorbitan tristearate, and mixtures thereof.

38. The candle according to claim 24, wherein said candle body composition comprises at least about 90 weight percent of a vegetable fat having an iodine value of about 40 to about 80, and up to about 10 weight percent of a crystal modifier, said crystal modifier being selected from the group consisting of fatty acids, esters of fatty acids, and mixtures thereof.

39. The candle according to claim 38, wherein said vegetable fat is selected from the group consisting of soybean oil, palm oil, cottonseed oil, rapeseed oil and mixtures thereof.

40. The candle according to claim 38, wherein the crystal modifier is an ester of a fatty acid selected from the group consisting of monoglycerides having an iodine value from about 1 to about 80, diglycerides having an iodine value from about 1 to about 80, propylene glycol monoesters, canola methyl esters, sorbitan tristearate, and mixtures thereof.

41. The candle according to claim 38, wherein the crystal modifier comprises a mixture of monoglycerides and diglycerides having an iodine value from about I to about 60.

42. A method of forming a candle, comprising:
melting a vegetable fat having an iodine value of about 20 to about 80 to form a liquefied vegetable fat;
contacting the liquefied vegetable fat with a candlewick such that a portion of the candlewick is coated with the vegetable fat; and
cooling the candlewick and vegetable fat coated thereon to form a solid candle.

43. The method according to claim 42, wherein said contacting step comprises:
positioning a candlewick within a mold; and
pouring the liquified vegetable fat into the mold such that the vegetable fat encases at least a portion of the candlewick.

44. The method according to claim 42, wherein said contacting step comprises dipping the wick repeatedly into the liquefied vegetable fat.

45. The method according to claim 42, wherein the vegetable fat is a partially hydrogenated vegetable oil.

46. The method according to claim 42, wherein the vegetable fat is a fully hydrogenated vegetable oil.

47. The method according to claim 42, wherein the vegetable fat is selected from the group consisting of soybean oil, palm oil, cottonseed oil, rapeseed oil and mixtures thereof.

48. The method according to claim 42, wherein said melting step comprises heating the vegetable fat at a temperature of about 120° F. to about 200° F.

49. The method according to claim 42, further comprising cooling the vegetable fat to a temperature of about 110° F. to about 180° F. prior to said contacting step.

50. The method according to claim 42, further comprising the steps of:
adding up to about 20 weight percent of at least one crystal modifier to the liquified vegetable fat prior to said contacting step; and
mixing the crystal modifier and the vegetable fat to form a uniform candle body composition.

51. The method according to claim 50, wherein said adding step comprises adding a crystal modifier selected from the group consisting of fully hydrogenated vegetable oils having an iodine value of about 1 to about 20, fatty acids, esters of fatty acids, and mixtures thereof.

52. The method according to claim 50, wherein said adding step comprises adding an ester of a fatty acid selected from the group consisting of monoglycerides having an iodine value from about 1 to about 80, diglycerides having an iodine value from about 1 to about 80, propylene glycol monoesters, canola methyl esters, sorbitan tristearate, and mixtures thereof.
